(19) United States
(12) Patent Application Publication
(10) Pub. No.: US 2005/0038714 A1
(43) Pub. Date: Feb. 17, 2005

(54) Self-service gift card dispensing terminal and method of use

(76) Inventors: John Bonet, Berlin, CT (US); William D. Hodge, Newington, CT (US); Jonathan Platt, Southington, CT (US); John Winchester, Avon, CT (US)

Correspondence Address: MCCORMICK, PAULDING & HUBER LLP, CITY PLACE II, 185 ASYLUM STREET, HARTFORD, CT, 06103, US

(21) Appl. No.: 10/856,972

(22) Filed: May 28, 2004

Related U.S. Application Data
(60) Provisional application No. 60/473,801, filed on May 28, 2003.

(51) Int. Cl. G06F 17/60

(52) U.S. Cl. 705/26

(57) ABSTRACT

A self-service gift card terminal for the purchase or activation of a gift card, the gift card terminal including a housing having a computer processor disposed in the housing. A user interface coupled to the computer processor provides for self-service interaction between a customer and the gift card terminal. A modem coupled to the computer processor and connectable to a network transmits data to and from the gift card terminal. The gift card terminal also includes means for accepting payment for a gift card purchase. The computer processor is configured to activate a gift card in accordance with a customer request for and purchase of a gift card. A receipt for the transaction is then printed. The self-service gift card terminal provides a convenient terminal from which a customer can purchase and activate a gift card from a plurality of retailers or service providers.

CROSS REFERENCE TO RELATED APPLICATIONS

This application claims priority to provisional patent application, Ser. No. 60/473,801 filed on May 28, 2003 entitled “Automated self service gift card dispensing and authorizing terminal”, the disclosure of which is incorporated herein by reference.

### FIELD OF THE INVENTION

The present invention relates generally to an apparatus and method for purchasing gift cards and more particularly to a self-service gift card terminal and method of use.

### BACKGROUND OF THE INVENTION

A gift card is a card that is purchased at a retailer or service provider for a certain dollar amount for the purpose of giving credit in the amount equal to the purchase price of the gift card to another person that is redeemable at through the retailer or service provider. The recipient can then redeem the gift card through the retailer or service provider from which it was purchased, for goods and services of his/her choice up to the amount of the gift card. Once a gift card is purchased, additional value can usually be added to the balance of the gift card in a subsequent purchase.

Currently gift cards are becoming a popular choice for a personal gift for acquaintances, friends or family members. However, one problem associated with purchasing a gift card, is that the purchaser is usually required to travel to a store location of a selected retailer or service provider to make the purchase. Thus, if a person wants to purchase two gift cards, each from a different retailer, the person would need to visit a store location for each of the retailers to complete the purchases.

Mall cards, which are often available in shopping malls, are gift cards which can be purchased at a shopping mall and which are redeemable at any of a number of stores associated with the particular mall at which the mall card was purchased. As such, mall cards have limited usefulness, as the purchaser of a mall card must travel to a particular shopping mall to purchase the mall card, and a recipient of the mall card must visit the same mall to redeem the card.

Based on the foregoing, it is the general object of the present invention to provide a self-service gift card terminal and method of use that overcomes the above-described problems and drawbacks present in the prior art.

### SUMMARY OF THE INVENTION

The present invention is directed to a self-service gift card terminal for the purchase and activation of a gift card in accordance with a customer request. The gift card terminal includes a housing having a computer processor disposed therein. A user interface is coupled to the computer processor for providing self-service interaction between a customer and the gift card terminal. A modem and/or network interface card connects the computer processor to a network for transmitting data to and from the gift card terminal. The gift card terminal includes means for accepting a payment from the customer for the purchase of a gift card. The computer processor is configured to activate a gift card in accordance with the purchase thereof. The activation process is discussed further hereinbelow.

The user interface includes a display for displaying information to the user as well as an alphanumeric keypad for inputting data to the computer processor. In a preferred embodiment, the display includes a touch screen wherein a customer can input information to the computer processor via the touch screen. A card reader or card scanner can also be coupled to the computer processor for receiving data from a credit card or a gift card.

In one embodiment of the present invention, the gift card terminal is a stand alone apparatus that is configured for the purchase and activation of gift cards from multiple retailers or service providers. For example, a gift card terminal according to the present invention can be located in an airport or train station whereby a person can purchase from a self-service terminal, a gift card from one of a plurality of retailers or service providers. The gift card terminal can be arranged to accept credit cards, debit cards or currency and provides a convenient device for the purchase and/or activation of gift cards. Additionally, the gift card terminal can be configured for processing gift card transactions through a Virtual Private Network (VPN), a closed network, or the Internet.

The term activation of a gift card refers to the process of completing the transaction related to the sale of a gift card, i.e. the purchase funds are transferred to an account of the selected retailer and an account or card number associated with the particular gift card to be activated is credited in an amount equal to the purchase price of the gift card. Usually, the name of the retailer at which the gift card is redeemable through is pre-printed on a face of the gift card. Thus, the gift card is actually a pre-paid debit card redeemable at a retailer from which it was purchased.

In addition to the sale and activation of gift cards, the gift card terminal of the present invention can be used to check the balance of, or to “reload” a previously purchased gift card. The term “reload” as used herein means to purchase additional credit to be added to an existing or previously purchased gift card. These transactions can be completed by using a card reader or scanner associated with the gift card terminal for identifying the actual gift card for which the balance is to be checked or additional value is to be added.

In one embodiment, the gift card terminal includes a display wherein blank gift cards from various retailers or service providers are stored and are selectable by a customer and can be purchased and activated via the gift card terminal. The gift cards can include an amount designation on a face of the card such as $25 or $50 wherein the purchase price equals the designated value of the card. Alternatively, the gift cards can be blank as to the value thereof, wherein the purchaser selects a desired amount for the gift card and the gift card is activated accordingly following payment of the selected value of the gift card.

Alternatively, the gift card terminal can be configured wherein a generic gift card supplied with, or dispensed from, the gift card terminal can be purchased and activated for redemption through a retailer or service provider selected from a plurality of retailers or service providers. In this embodiment, the purchaser selects a retailer from a list of retailers as well as a value for the gift card. Following payment of the selected value by the purchaser, the computer processor then activates a generic card for redemption at the selected retailer in an amount equal to the selected value. The gift card terminal can include means for labeling or imprinting the gift card with the name or logo of the selected retailer or service provider at which the gift card is redeemable.

In either of the above-identified embodiments, the present invention gift card terminal provides for the sale and activation of gift cards for any number of retailers from a single self-service location.

Additionally, the present invention gift card terminal can be used for the purchase of mall cards as discussed above. Accordingly, the self-service gift card terminals could be positioned throughout a shopping mall and configured to provide for the purchase and activation of mall cards redeemable at any of a number of participating stores or shops associated with a particular shopping mall or chain of malls. The gift card terminals can be positioned in locations accessible after hours such that the mall cards can be purchased at any time whether or not the mall is open for business.

In another embodiment, a gift card terminal according to the present invention can be configured for the sale and activation of gift cards redeemable at particular retailer or service provider. This embodiment of the gift card terminal is useful for large retailers so that a consumer can stop by a store location and utilize a self-service gift card terminal for purchasing a gift card. This allows a customer to purchase a gift card quickly without waiting for a clerk, and provides an automated means for a retailer to sell gift cards without the use of a clerk's time. Alternatively, a single retailer gift card terminal as described above, could be located at other places remote from a store location.

In still another embodiment, the gift card terminal of the present invention can be configured for the self-service purchase of pre-paid bank cards or debit credit cards such as a pre-paid Visa® or Mastercard®. For example, a pre-paid Visa® or Mastercard® can be purchased through the gift card terminal from an associated bank and can be used anywhere that accepts Visa® or Mastercard®.

### BRIEF DESCRIPTION OF THE DRAWINGS

FIG. 1 is a front view of one embodiment of a gift card terminal according to the present invention;

FIG. 2 is a side view of the FIG. 1 embodiment of the present invention;

FIGS. 3A and 3B are illustrations of front and rear sides respectively of one embodiment of a typical gift card from a large retailer as used with the present invention;

FIGS. 4A and 4B are front and rear side views of one embodiment of a generic gift card in accordance with the present invention;

FIG. 5 is a flow chart illustrating a summary of the system process according to one embodiment of the present invention gift card terminal;

FIG. 6 is a flow chart illustrating a check balance process for a gift card according to the present invention;

FIGS. 7A-7C are a flow chart illustrating a reload card process for a gift card according to the present invention;

FIG. 8 is a flow chart illustrating an activation process for a gift card reload process according to the present invention;

FIGS. 9A and 9B are a flow chart illustrating a new card purchase process for a gift card according to the present invention;

FIG. 10 is a flow chart illustrating an activation process for a gift card purchase process according to the present invention; and

FIG. 11 is a flow chart illustrating a credit card authorization process as used with the present invention.

### DETAILED DESCRIPTION OF PREFERRED EMBODIMENTS

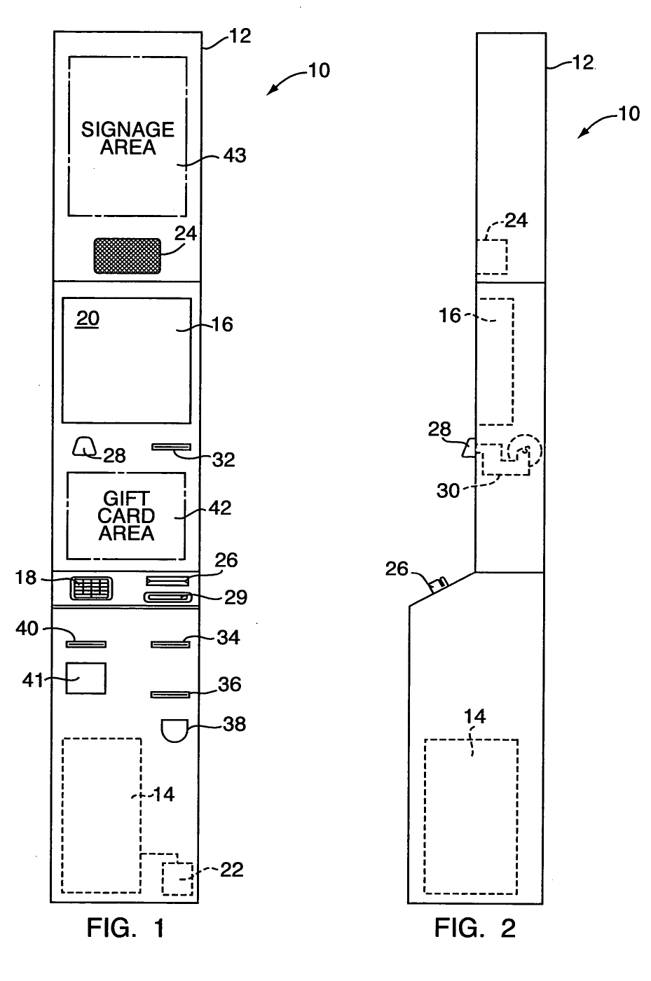

As shown in FIGS. 1 and 2 a gift card terminal according to the present invention is generally designated by the reference numeral 10. The gift card terminal 10 includes a housing 12 and a computer processor 14 disposed in the housing. The gift card terminal 10 has a user interface including a display 16 and key pad 18 mounted to the housing 12 and coupled to the computer process 14. The display 16 has a touch screen 20 for user input of data to the computer processor 14. A modem 22 is coupled to the computer processor 14 and connectable to a network for transmitting data to and from the gift card terminal 10. In the illustrated embodiment, the gift card terminal 10 includes a speaker 24 that is coupled to the computer processor 14 for playing music or providing audible instructions to a user.

A card reader 26 is mounted to the housing 12 and coupled to the computer processor 14 for inputting data from a credit card or gift card. Additionally, a scanner 28 is coupled to the computer processor 14 and provided for scanning barcodes or other data stored on credit cards or gift cards. The gift card terminal 10 can also be equipped for processing smart cards, Bluetooth® enabled, wireless or other network cards for use in gift card transactions. A signature verification pad 29 is provided for inputting a user's signature for use in a credit, debit or other card verification process.

A printer 30 for providing receipts for gift card transactions is mounted inside the housing 12 adjacent to a printer opening 32 defined by the housing 12. The printer 30 is coupled to the computer processor 14 and can also be configured for printing promotional information or coupons.

The gift card terminal 10 accepts and dispenses currency via a bill acceptor/dispenser 34, a coin acceptor 36 and a coin dispenser 38, each of which are coupled to and controlled by the computer processor 14. Advertising can be displayed on the gift card terminal 10 at a signage area 44.

Blank gift cards or bankcards are dispensed from the gift card terminal via a gift card dispenser 40. Additionally, blank gift cards can be stored on an exterior surface of the gift card terminal 10 at a display area 42.

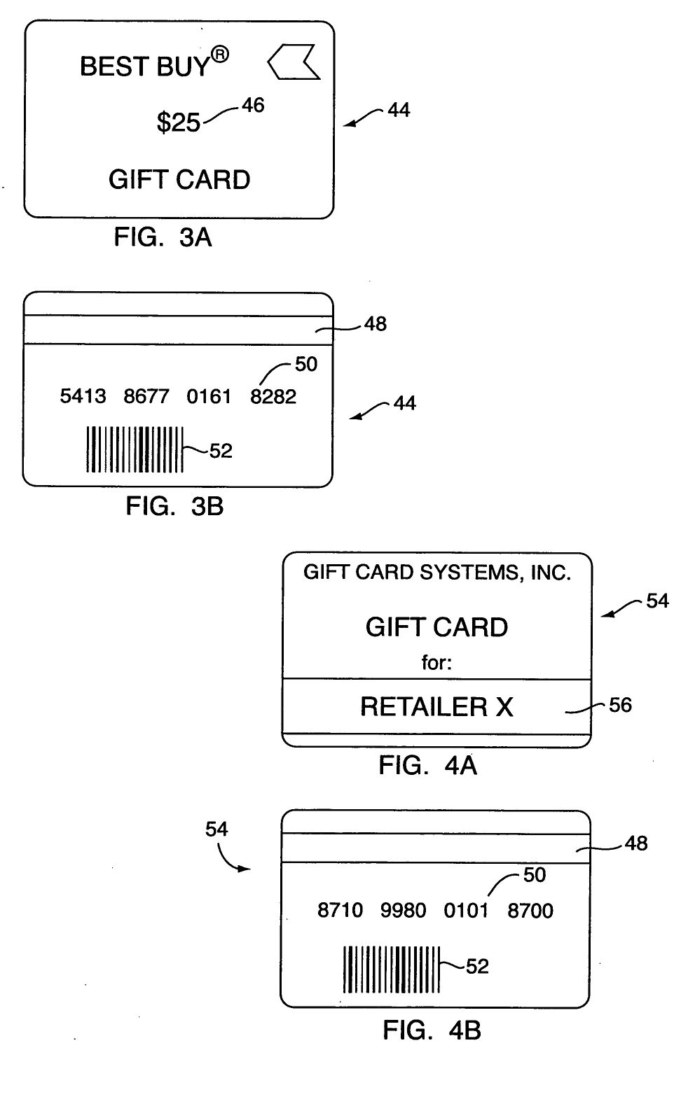

FIGS. 3A and 3B show the front and rear sides respectively of a typical $25 gift card 44 supplied from a retailer such as Best Buy®. The value designation 46 shown on the front of the card indicates a predetermined value for the gift card 44, which is also the cost to purchase the gift card. The rear of the gift card 44 includes a magnetic strip 48, a serial number 50, and a barcode 52. Typically, the magnetic strip 48, the serial number 50 and the barcode 52 all include information identifying the retailer, the designated value of the gift card, as well as a serial number of the actual gift card 44. A variable value gift card (not shown) is similar to the gift card 44 without the value designation 46 as the value is to be selected by the purchaser of the gift card. For example, the same blank gift card could be purchased for $50 dollars, $100 dollars, or any other amount, wherein the activation process would allocate the appropriate amount of funds in an account of the retailer corresponding to the serial number 50 of the gift card. When a holder of the card returns to the retailer to purchases goods, some or all of the purchase price of the goods can be offset by presenting the gift card. Typically, a clerk for the retailer simply swipes the magnetic strip 48 on the rear of the card through a card reader thereby entering the serial number 50 of the card into the retailer's computer system. The retailer's computer system then accesses a gift card database and retrieves a balance designated as corresponding to the gift card presented. Typically, the customer can request any portion of the balance of funds allocated to the gift card to be used to complete the purchase of the goods.

Following the above-identified gift card transaction, if a balance remains on the gift card, the customer retains the gift card for a subsequent purchase. If the balance of the funds on the gift card is depleted, the gift card is useless to the customer, unless the holder of the gift card intends to purchase additional credit and reload the gift card for further use.

FIGS. 4A and 4B illustrate the front and rear sides of a generic gift card 54. The generic gift card 54 includes an area 56 in which the name of a selected retailer can be identified on the gift card. The gift card terminal 10 can include means for labeling or imprinting a generic gift card 54 in accordance with a purchaser's selection. Gift card terminal 10 includes a labeler 41 mounted inside the housing 12 for labeling a generic gift card 54. The rear side of the generic gift card 54 also includes a magnetic strip 48, a serial number 50 and a barcode 52 similar to those discussed above with respect to the retailer gift card 44. The purchase, activation and reloading processes of a generic gift card 54 are similar to that of a gift card provided by a specific retailer, however, depending on the processing system, the generic gift card 54 may be processed through both a gift card vendor as well as the selected retailer for which the generic gift card was purchased.

Thus, the only difference between the generic gift card 54 and the retailer's gift card 44 is that the generic gift card 54 enables the gift card terminal 10 to provide gift cards from any number of retailers. For example, a gift card vendor can be associated with literally thousands of retailers or service providers and offer gift cards for sale at a single gift card terminal 10 that are redeemable at any one of the associated retailers or service providers.

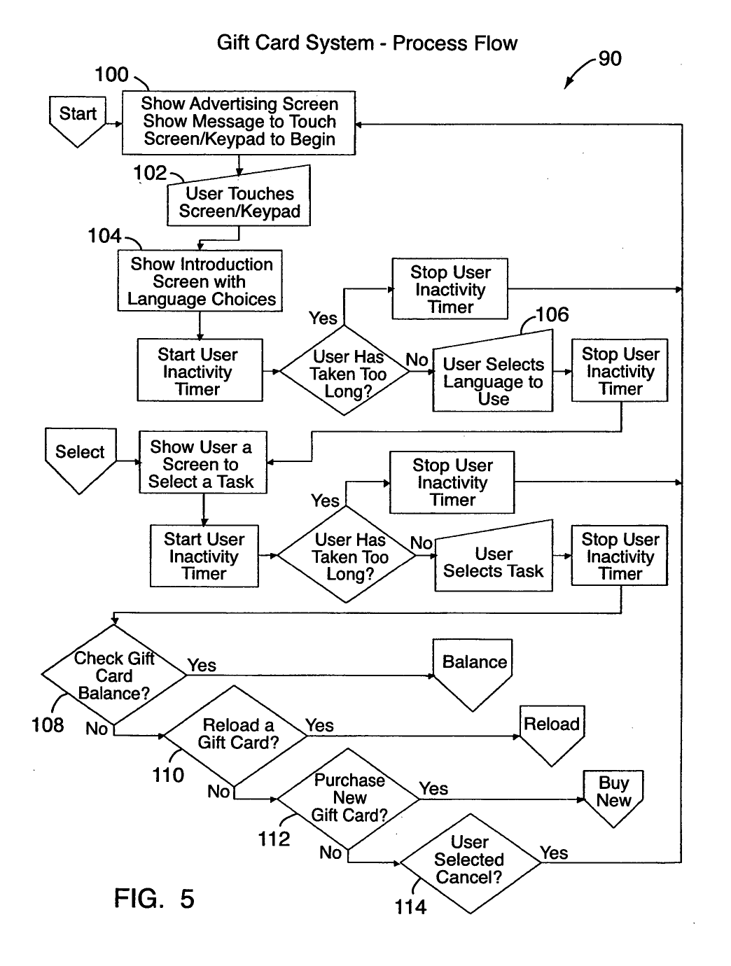

Referring to FIGS. 5, the system process of the gift card terminal 10 is designated generally with the reference number 90. The system process 90 begins with a screen saver including advertising for the gift card terminal 10 in an idle state at block 100. To initiate a process on the gift card terminal 10, a user simply touches the touch screen 20 or keypad 18 as shown at block 102. The user is offered a choice of languages at block 104 and completes a language selection at block 106. The system process 90 proceeds to offer various task selections including 1) Check gift card balance? (block 108); 2) Reload a gift card? (block 110); 3) Purchase new gift card? (block 112); or Cancel? (block 114).

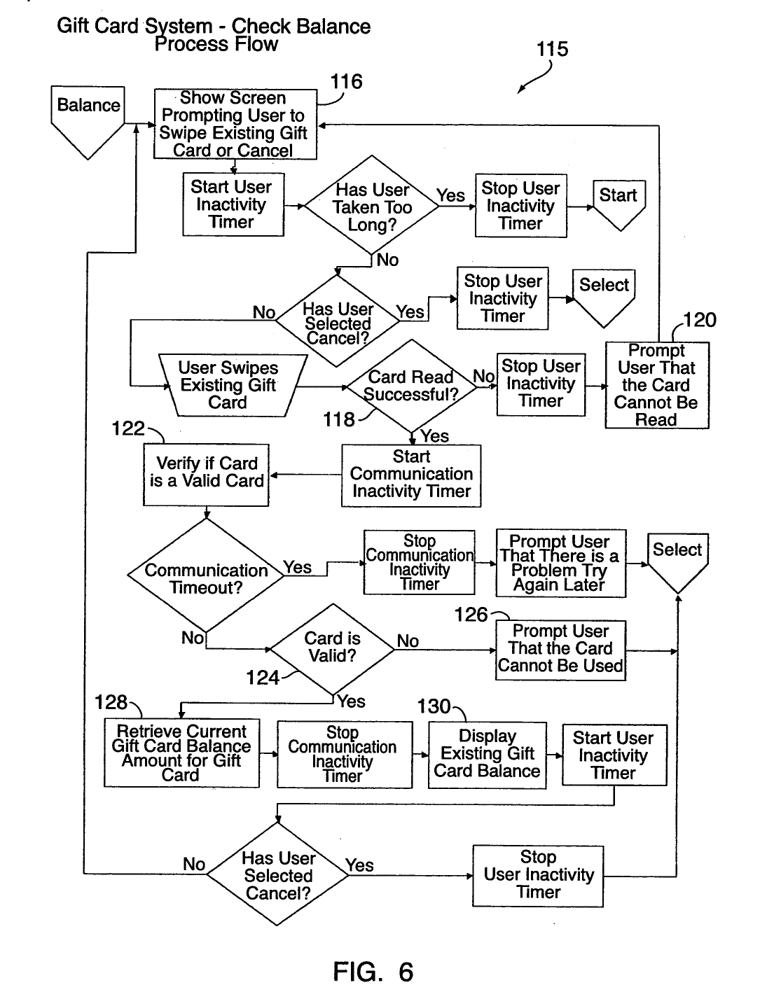

Referring to FIG. 6, a check gift card balance process is illustrated generally by the reference numeral 115. If the user selects “Check gift card balance?” (block 108), the process continues at block 116 by prompting the user to swipe an existing gift card 46 or 54 through the card reader 26 on the gift card terminal 10, (block 142). At decision block 118, the computer processor 14 determines whether or not the gift card 44, 54 swiped is identifiable. If the gift card 44, 54 is unreadable or otherwise unidentifiable, the user is informed accordingly at block 120. Once the gift card 44, 54 is identified, the validity of the gift card 44, 54 is verified with the appropriate vendor at block 122 and utilized at decision block 124. If the gift card 44, 54 is not valid, an appropriate message is displayed to the user at block 126. For valid gift cards, the amount of the balance of funds allocated to the gift card 44, 54 is retrieved at block 128 and displayed to the user at block 130 and the check gift card balance process ends. Alternatively, the user could request that the balance of the gift card 44, 54 be printed on a receipt.

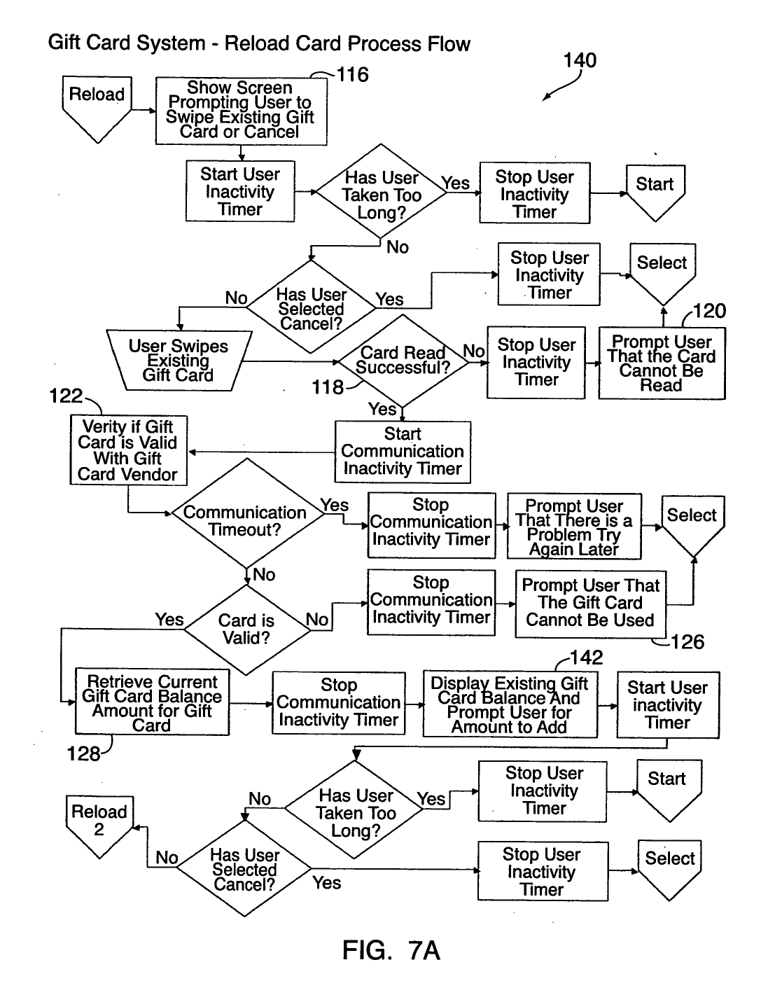

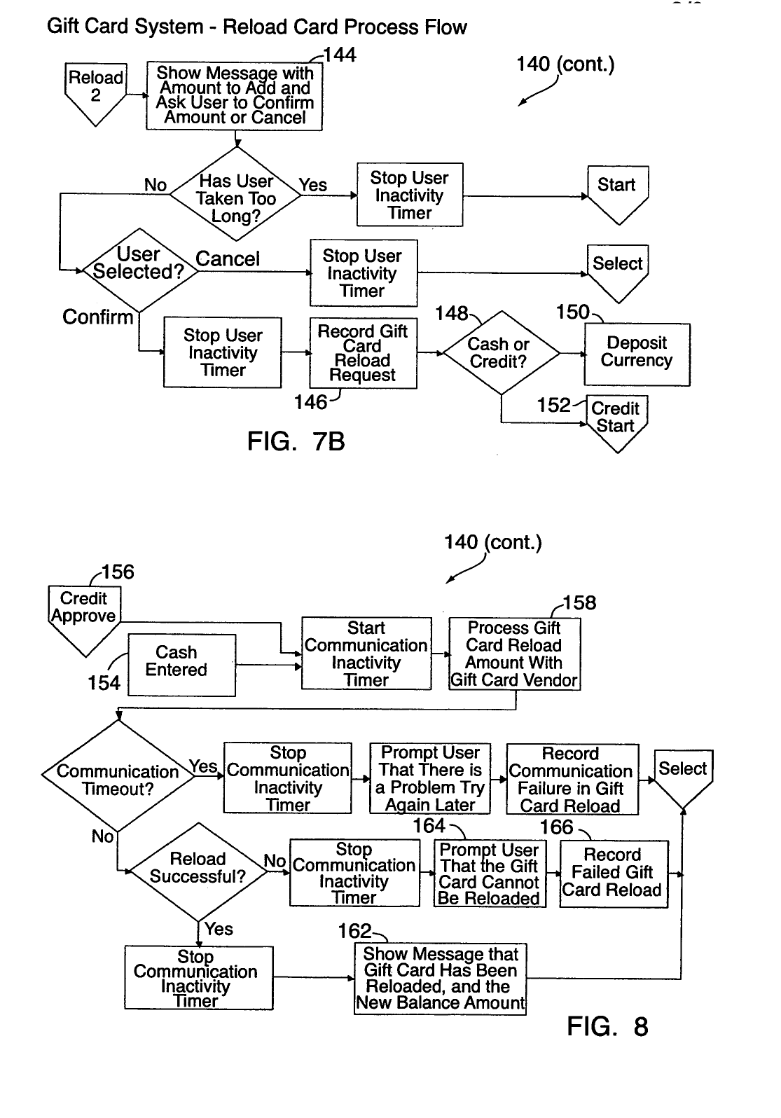

FIG. 7 illustrates one embodiment of a reload card process executed upon user selection of the “Reload a gift card?” option at block 110. The reload card process is generally designated by the reference number 140. The reload card process 140 begins similar to the check gift card balance process 115 and includes many of the same sub-processes as indicated with like reference numerals. The reload process 140 begins with a prompt 116 requesting the user to swipe an existing card to be reloaded with additional credit to be purchased. The reload process proceeds through blocks 118, 120, 122, 126 and 128 as set forth above with respect to the check current balance process 115 for a gift card. At block 128, the reload process 140 retrieves the current balance of the gift card 44, 54 to be reloaded. At block 142, the current balance of the gift card 44, 54 is displayed along with a prompt requesting the user enter an additional amount to be purchased and added to the gift card balance.

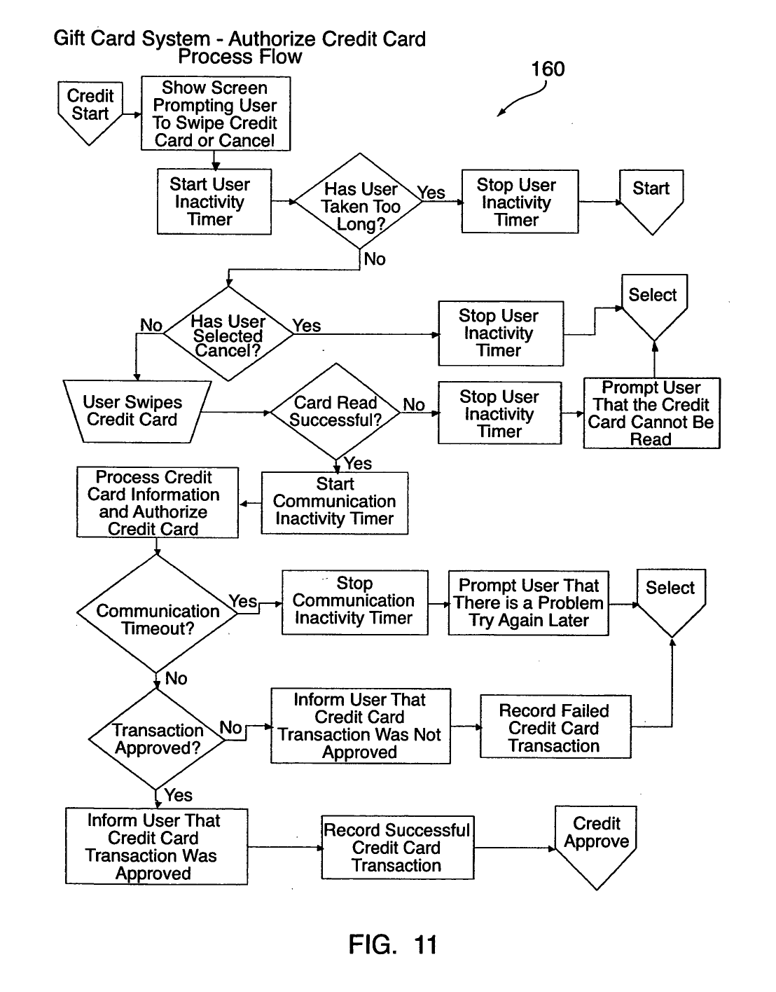

Referring to FIG. 7B, the reload process 140 continues at block 144 wherein the user is prompted to confirm the reload amount entered. The system records the reload request at block 146 and the reload process 140 proceeds at block 148 wherein the user selects a cash or credit purchase for the payment of the additional value to be added to the gift card 44, 54. For cash purchases, the user is prompted to enter currency via the bill acceptor/dispenser 34 or the coin acceptor 36 at block 150. Upon acknowledgement of the deposit of the reload amount, the reload process 140 continues at block 158 shown in FIG. 8. For credit purchases, (block 152) the reload process 140 continues with a typical credit card authorization process referred to generally by the reference numeral 160 as shown in FIG. 11. The credit card authorization process 160 will not be discussed further herein.

Whether via a cash or credit purchase, the reload process 140 resumes as shown in FIG. 8 at block 154—cash entered, or block 156—credit approved. At block 158, the reload process 140 continues wherein the amount of the customer's purchase is transferred to the appropriate retailer or gift card vendor to be credited to the serial number or account corresponding to the gift card 44, 54 being reloaded. Upon successful reloading of the gift card 44, 54, determined at decision block 163, a message acknowledging the reload and displaying the new balance of the reloaded gift card is provided at block 162. If a problem occurs in the reload process, an appropriate message is displayed to the user at block 164. The reload process 140 records the failed reload at block 166.

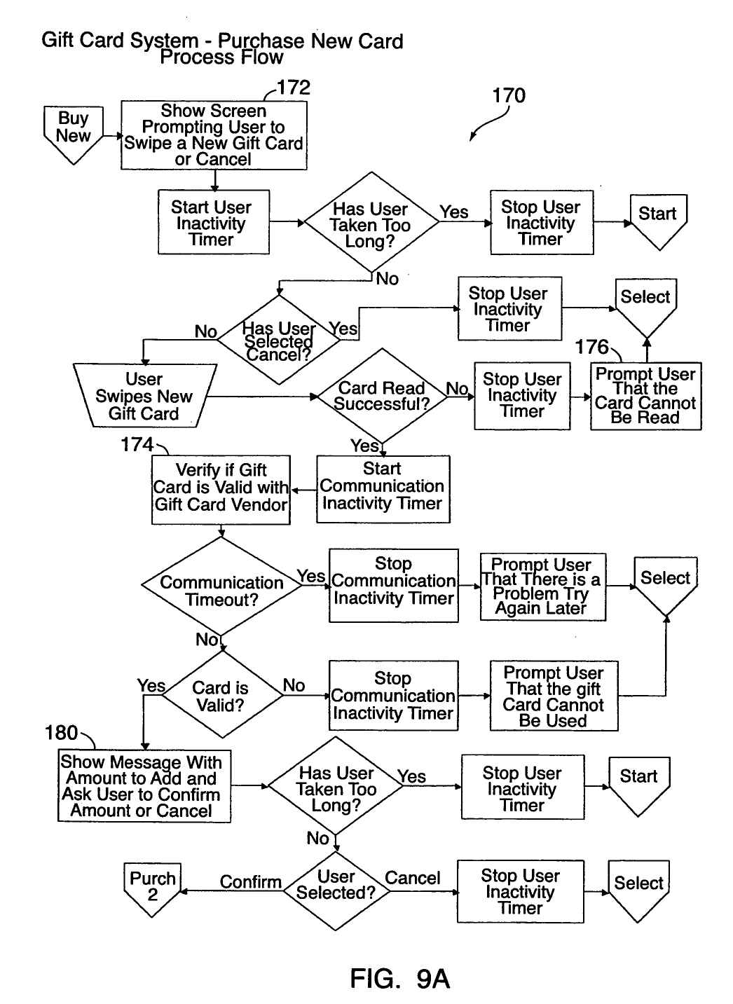

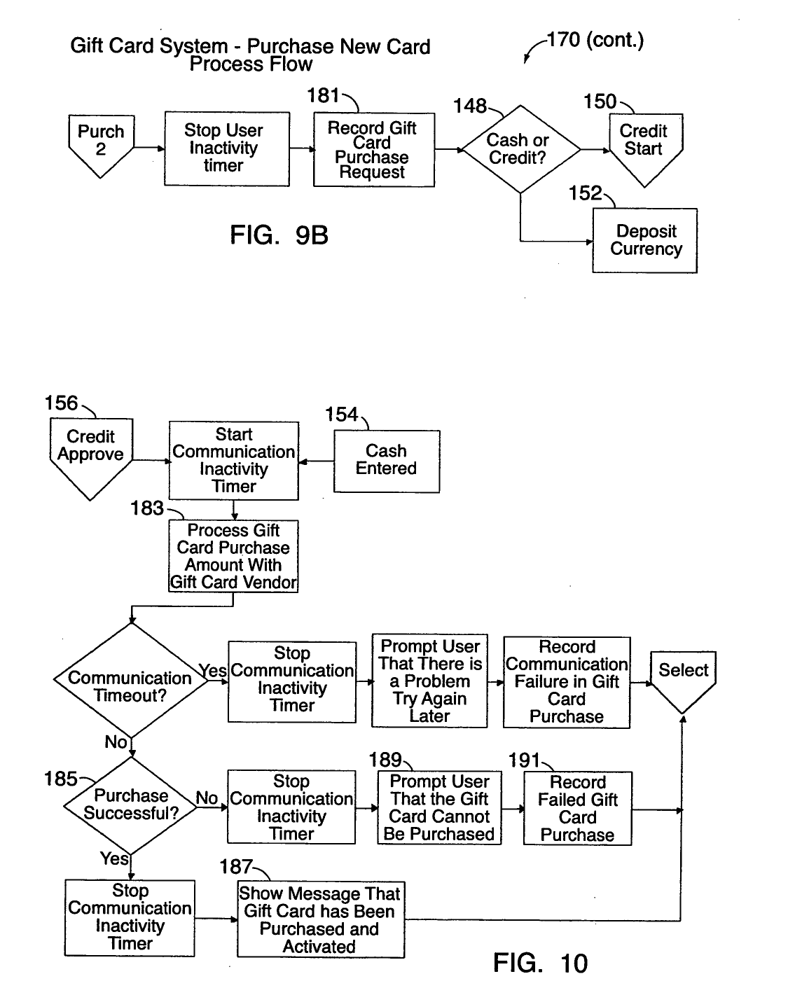

A purchase new gift card process is referred to generally by the reference numeral 170 as shown in FIGS. 9A and 9B. Following selecting “Purchase new gift card?” at block 112, a user is prompted to select a new gift card 44, 54 at block 172 and swipe the new gift card through the card reader 26 or scanner 28. The new gift card can be a retailer gift card 44 or a generic gift card 54. For generic gift cards, an additional query is presented to the purchaser wherein a user is provided with a list of retailers or service providers to select from. The generic gift card 54 purchased will be redeemable through the selected retailer or service provider and labeled accordingly as discussed above. In either case, the purchase new card process 170 resumes at block 174 wherein the swiped gift card is verified for authenticity with the appropriate retailer or gift card provider. If the new gift card 44, 54 cannot be read or is damaged, the user is provided an appropriate message at block 176. If the new gift card 44, 54 is not valid for use with the corresponding retailer or gift card provider, the user is informed accordingly through a displayed message at block 178. An invalid gift card may be one that has been reported lost or stolen.

At block 180, the purchase process 170 resumes with the user being queried as to how much credit does the user want to purchase to be allocated to, and added to the balance of the gift card 44, 54. For new purchases of designated value gift cards such as gift card 44, the customer knows the designated amount of the gift card 44 and the designated value information has been inputted to the computer processor 14 via the magnetic strip 48 when the gift card was swiped at block 172. Thus, the customer merely is asked to confirm the purchase amount. Otherwise for gift cards that do not include a designated value, the customer is asked first to enter a purchase amount and then to confirm the entered amount.

Referring to FIG. 9B, the purchase new card process 170 continues at block 181 wherein the system records the purchase request. At block 148 the user selects a cash or credit purchase for the payment of the purchase price to be allocated to the gift card 44, 54. For cash purchases, the user is prompted to enter currency via the bill acceptor/dispenser 34 or the coin acceptor 36 at block 150. For credit purchases, (block 152) the purchase process 170 continues with a the credit card authorization process referred to generally by the reference numeral 160 as shown in FIG. 11. Upon acknowledgement of the deposit of the purchase amount, the purchase process 170 continues as 'shown in FIG. 10.

Whether via a cash or credit purchase, the purchase process 170 resumes as shown in FIG. 10 at block 154—cash entered, or block 156—credit approved. At block 183 the purchase process 170 continues wherein the amount of the customer's purchase is transferred to the appropriate retailer or gift card vendor to be credited to the serial number or account corresponding to the gift card 44, 54 being purchased. Upon successful purchase of the gift card 44, 54, determined at decision block 185, a message acknowledging the purchase and displaying the new balance of the purchased gift card is provided at block 187. If a problem occurs in the purchase process 170, an appropriate message is displayed to the user at block 189. The purchase process 170 records the failed purchase at block 191.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

1. A self-service gift card terminal for the purchase or activation of a gift card comprising:
a housing;
a computer processor disposed in the housing;
a user interface coupled to the computer processor providing for self-service interaction between a customer and the gift card terminal;
a modem coupled to the computer processor and connectable to a network for transmitting data to and from the gift card terminal;
means for accepting payment for a gift card purchase; and wherein the computer processor is configured to activate a gift card in accordance with a customer request for and purchase of a gift card.

2. The self-service gift card terminal according to claim 1 wherein the user interface includes a display for displaying information to the user.

3. The self-service gift card terminal according to claim 2 wherein the display further comprises a touch screen whereby a user can input information to the computer processor via the touch screen.

3. The self-service gift card terminal according to claim 1 further comprising a card reader coupled to the computer processor for receiving data from a credit card or a gift card.

4. The self-service gift card terminal according to claim 1 further comprising at least one of a currency receiver and currency dispenser.

5. The self-service gift card terminal according to claim 1 wherein the computer processor is programmed for activating a gift card redeemable at a selected retailer in accordance with a user request.

6. The self-service gift card terminal according to claim 1 further comprising labeling means for labeling a generic gift card with identifying information corresponding to a selected retailer.

7. The self-service gift card terminal according to claim 1 further comprising means for storing or displaying blank gift cards corresponding to a plurality of retailers.

8. The self-service gift card terminal according to claim 1 further comprising means for dispensing a gift card.

9. The self-service gift card terminal according to claim 1 further comprising a printer coupled to the computer processing for printing at least one of a receipt for a gift card purchase, an information sheet, and a promotional coupon.

10. The self-service gift card terminal according to claim 1 further comprising means for effecting a gift card purchase transaction between a customer and at least one of a retailer, bankcard vendor, and gift card vendor.

11. A self-service method for purchasing and activating a gift card redeemable through a retailer or service provider, the method comprising the steps of:
receiving a customer request for a gift card;
accepting a payment for the requested gift card via a self-service terminal;
activating a gift card corresponding to the user request; and
providing the activated gift card for receipt thereof by the customer.

12. The method of claim 11 wherein the step of receiving a customer request for a gift card further comprises a step of selecting a retailer for the gift card from a plurality of retailers.

13. The method of claim 11 wherein the step of receiving a customer request for a gift card further comprises a step of selecting a value for the gift card.

14. The method of claim 11 wherein the step of accepting a payment further comprises a step of processing credit card information for authorizing a credit card sale for the payment.

15. The method of claim 12 wherein the step of activating a gift card further comprises a step of activating a gift card corresponding to the selected retailer.

16. The method of claim 12 wherein the step of activating a gift card further comprises a step of labeling a generic card corresponding to the selected retailer.

17. The method of claim 12 wherein the step of selecting a retailer further comprises selecting a plurality of associated retailers wherein the gift card is redeemable at any of the associated retailers.

18. The method of claim 10 wherein the step of selecting a customer request for a gift card further comprises selecting a bankcard such as Visa® or MasterCard® wherein the gift card to be purchased is a bankcard debit card.
